(19) United States
(12) Patent Application Publication
(10) Pub. No.: US 2013/0086937 A1
(43) Pub. Date: Apr. 11, 2013

(54) OIL CIRCULATION SYSTEM FOR A REFRIGERATION CHILLER

(71) Applicants: Luther D. Albertson, Sellersburg, IN (US); Mark B. Key, Greenwood, IN (US)

(72) Inventors: Luther D. Albertson, Sellersburg, IN (US); Mark B. Key, Greenwood, IN (US)

(21) Appl. No.: 13/268,224

(22) Filed: Oct. 7, 2011

(51) Int. Cl. F25B 41/00; F25B 1/00; B23P 15/26

(52) U.S. Cl. 62/468; 29/890.035

(57) ABSTRACT

An oil circulation system for a refrigeration chiller including a pump coupled to an atomizing spray nozzle located near the compressor suction inlet spraying a fine mist of oily liquid from the evaporator to be aspirated by the compressor.

### BACKGROUND OF THE INVENTION

The present invention relates to refrigeration chillers, particularly to the circulation of compressor lubricant trapped in the evaporator. Oil migration from the chiller compressor to the evaporator is a very old problem and occurs in virtually all compressor-driven chiller systems. Without proper lubrication, the compressor must be shut down to avoid excessive wear. This is especially true for chillers using screw compressors which require large amounts of oil to lubricate, seal, and cool the compressor.

Numerous lubricant circulation techniques exist for recovering oil entrained in the chiller's refrigerant charge. Oil separators placed in the refrigeration circuit remove all but a tiny fraction of the oil in the refrigerant but cannot capture all of it. The uncaptured compressor lubricant migrates into the evaporator where it rests in the refrigerant charge as an oily liquid that must be circulated back to the compressor by other means. Eductors are commonly used for this purpose and are often part of a factory installed oil return system. In this application of an eductor, a high pressure stream of refrigerant gas flows through the eductor nozzle drawing the oily liquid from the evaporator back into the compressor. In this way, an eductor can recover oil effectively provided the pressure differential between the compressor inlet and compressor discharge is sufficiently high. This pressure differential (compressor “lift”) is proportional to the cooling load on the chiller and is highest when the chiller is under heavy load.

However, relying on compressor lift to recover compressor lubricant often causes increased oil migration with decreased circulation and recovery. Chiller compressors often operate at low lift for extended periods resulting in further pressure reductions in the eductor and reduced oil circulation from the evaporator back to the compressor. These reductions in compressor lift can also cause oil to slide down out of the compressor inlet into the evaporator. As a result, with the exception of the most recent chiller designs, rotary screw compressors cannot operate below 25 to 30% of their rated capacity for an extended period of time without experiencing excessive oil loss. When compressor lift is too low to properly circulate oil, oil migration continues until either the load on the chiller increases thereby increasing compressor lift, or the chiller shuts down due to low oil volume to avoid harming the compressor. When the chiller shuts down for lack of oil, it is then very difficult to recover oil from the refrigerant charge in the evaporator.

Adding extra oil to the compressor oil reservoir is also not always possible either. First of all, as lubricant builds up in the evaporator, the evaporator's performance efficiency is degraded. Secondly, excessive foaming can occur when the chiller is started which causes liquid refrigerant to be carried into the compressor, reducing the compressor discharge temperature. As the compressor discharge temperature approaches the condenser saturation temperature, the affinity of the refrigerant gas to absorb oil can increase to a point where oil can no longer be separated from the refrigerant.

There remains, then, a need for a reliable cost efficient system for continuously circulating compressor lubricant from the chiller refrigerant under all operational loads that can be added relatively quickly to a wide range of existing chillers without expensive modifications.

### SUMMARY OF THE INVENTION

The present invention addresses the concerns mentioned above as well as others by providing a system for circulating lubricant from the evaporator to the compressor of a refrigeration chiller that operates regardless of compressor lift and can be added to an existing chiller with minimal modifications.

The invention adds a second pump which operates in tandem with the chiller's existing oil circulation system to introduce a discharge of oily liquid from the evaporator to the compressor. Both pumps take the same oily liquid from the evaporator and pump it to a discharge near the compressor suction inlet. This discharge can be a discharge common to both pumps, or a separate discharge for each. In one embodiment of the invention, the existing oil circulation system relies on a factory installed eductor pump while the second pump is a magnetically coupled gear pump coupled to an atomizing nozzle positioned near the compressor suction inlet. The second pump sprays a fine mist of oily liquid from the nozzle near the compressor suction inlet that is sucked into the compressor and circulated back through the compressor regardless of compressor load. The invention also includes automatic controls to operate the second pump as a backup only when the primary oil circulation system fails or only when a low lift situation develops.

The present invention also provides a relatively easy and inexpensive method to retrofit the invention to existing refrigeration chillers. By obtaining the second pump and coupling it to the evaporator and a discharge near the compressor suction inlet, the chiller is inexpensively readied to take advantage of the benefits of the invention.

Various forms, objects, features, additional aspects, advantages, and embodiments of the present invention will become apparent to those of ordinary skill in the art from the following detailed description when read in light of the accompanying drawing.

### BRIEF DESCRIPTION OF THE DRAWING

FIG. 1 is a partial cross sectional view of the present invention installed in a refrigeration chiller with a screw-type compressor.

### DESCRIPTION OF THE PREFERRED EMBODIMENTS

For the purpose of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates. One embodiment of the invention is shown in great detail, although it will be apparent to those skilled in the relevant art that some features that are not relevant to the present invention may not be shown for the sake of clarity.

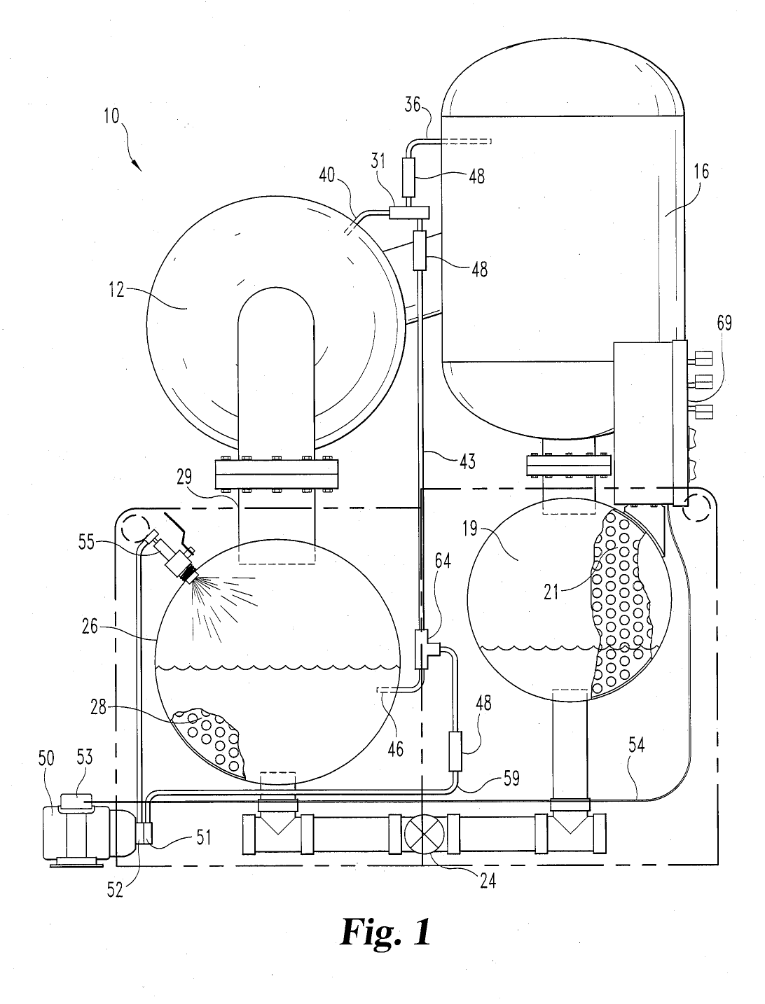

The refrigeration chiller at 10 includes a compressor 12, an oil separator 16, a condenser 19, an expansion valve 24, and an evaporator 26 coupled together to form a complete refrigeration circuit. The refrigeration cycle begins when compressor 12 compresses a refrigerant gas which is delivered to condenser 19 through the oil separator 16. Inside condenser 19, the refrigerant gas cools as it condenses on the exterior surfaces of tube bundle 21 and falls to the bottom of condenser 19 as a liquid. A cooling medium flowing through tube bundle 21 carries away heat from the refrigerant gas which is cooled by other means to allow this condensation to occur continuously inside condenser 19. FIG. 1 shows a partial cross section of a common shell and tube type condenser where the cooling medium is a liquid such as water flowing through tube bundle 21. However, other embodiments of condenser 19, such as an air-cooled condenser, are also envisioned and are within the scope of the invention.

After condensing to a liquid, refrigerant flows from condenser 19 to expansion valve 24. The pressure on the condenser side of expansion valve 24 is much higher than on the evaporator side. Because of this, refrigerant passing through expansion valve 24 expands and cools changing from a relatively warm liquid to a much cooler two phase liquid and gas mixture as it flows into evaporator 26. The cooler liquid refrigerant phase flowing into evaporator 26 then contacts tube bundle 28 through which a second external cooling medium flows. As the cool liquid refrigerant phase contacts the exterior walls of the tubes in tube bundle 28, heat from the cooling medium flowing inside the tubes warms the liquid refrigerant causing it to vaporize. The cooling medium then leaves tube bundle 28 at a lower temperature to cool an external heat load while the now vaporized refrigerant gas rises to the upper interior portions of evaporator 26. Evaporator 26 in FIG. 1 is preferably a flooded evaporator design with tube bundle 28 substantially immersed in liquid refrigerant as shown. However, other types of evaporators with different arrangements of tube bundles 28 and refrigerant levels are envisioned as well. As the refrigerant absorbs heat and vaporizes, it is aspirated by compressor 12 through compressor suction inlet 29, compressed and delivered back to condenser 19 and evaporator 26 in an ongoing process.

Various types of compressors are used to compress refrigerant gas in a refrigeration chiller. One embodiment is the very common screw-type compressor which operates by rotating screw rotors within a working chamber. In this embodiment of compressor 12, relatively large quantities of oil are required to lubricate, cool, and seal the compressor. This means compressor lubricant is in direct contact with hot refrigerant gas under high pressure which results in significant quantities of oil being dissolved in the refrigerant, or refrigerant dissolved in the oil, or both. Furthermore, some oil is physically picked up with the high velocity refrigerant exiting the compressor discharge as well. Other embodiments of compressor 12 are envisioned which may operate differently but suffer the same loss of significant quantities of compressor lubricant into the refrigerant charge during compression.

To recapture lubricant lost from compressor 12, oil separator 16 is placed between compressor 12 and condenser 19. Most embodiments of oil separator 16 used in refrigerant chillers are very efficient and will capture all but a very small portion of the oil combined with the refrigerant moving from compressor 12 through oil separator 16. However, it is not uncommon for a small amount of oil to be carried through oil separator 16 with the refrigerant gas and into condenser 19.

Because of the relatively high pressures and temperatures, lubricant does not rest long in the condenser, but migrates into evaporator 26 where it resides as an oily liquid having a higher concentration of oil than the liquid refrigerant phase in evaporator 26. As previously noted, this oily liquid is lubricant in various forms that the oil separator 16 failed to capture and includes oil, refrigerant dissolved in oil, oil dissolved in refrigerant, or combinations thereof. Depending on the properties of the liquid refrigerant phase in evaporator 26, the oily liquid may separate to the top of the liquid refrigerant phase, or it may collect at the bottom of it. In some cases and at various times, the oily liquid may develop into a foam on the surface of the liquid refrigerant phase, or be more dispersed in some areas of evaporator 26 than others depending on the unique situation present. Regardless of precisely how it is dispersed, unless the oily liquid in evaporator 26 is timely returned to compressor 12, the entire supply of compressor lubricant will eventually migrate to evaporator 26 resulting in negative outcomes such as reduced efficiency, damage to compressor 12, or premature shutdown of refrigeration chiller 10.

Various methods have been devised for capturing and circulating the oily liquid back to the compressor. Many oil circulation systems installed as original equipment on chillers rely on eductors to perform this task. Eductors, also known as “jet pumps” or “venturi pumps,” move the oily liquid using a high rate of flow of refrigerant vapors past an opening that is coupled to the evaporator. The high rate of flow creates a vacuum that draws the oily liquid from the evaporator. FIG. 1 shows an embodiment of an eductor pump 31 which normally maintains the necessary high rate of flow of refrigerant vapors from high pressure line 36 which is attached to oil separator 16. Oil separator 16 receives a steady supply of high pressure refrigerant gas directly from compressor 12. Other embodiments of refrigerant chiller 10 could also connect high pressure line 36 elsewhere including, but not limited to, compressor 12 or condenser 19. The vacuum created by the fast moving vapors moving through eductor pump 31 creates suction on suction line 43 causing oily liquid to be retrieved from evaporator 26 via evaporator oil skimmer 46. As a result, vapors from high pressure line 36 and oily liquid from suction line 43 combine inside eductor pump 31 before entering compressor 12 at a discharge near the suction inlet at return line 40.

However, in some situations, eductor pump 31 will not pump enough oily liquid from evaporator 26 to avoid excessive oil loss. If high pressure line 36 does not carry enough pressure to move vapors fast enough past the opening in eductor pump 31 to create enough vacuum to draw oily liquid up suction line 43, insufficient lubricant will circulate back to compressor 12. This can occur in various situations, most notably, when the chiller is operating at low load. As the heat load begins to drop, refrigeration chiller 10 responds by reducing the discharge pressure of compressor 12. Reduced load results in reduced “lift,” or a narrowing of the difference between the compressor suction and discharge pressures. As compressor 12 begins to reduce its discharge pressure and lift is reduced, the flow of vapors motivating eductor pump 31 to move oily liquid out of evaporator 26 is also reduced. If lift is reduced too far, eductor pump 31 will cease to adequately circulate lubricant, and oil will collect in evaporator 26 with inadequate quantities returning to compressor 12 until lift is increased.

The present invention addresses the problem of excessive oil loss due to low compressor lift by adding a second pump, shown in FIG. 1 as mechanical pump 50 having an inlet 51, and outlet 52, a pump controller 53, and a pump control cable 54. This is preferably done as a retrofit to existing units that risk inadequate oil returns. Inlet 51 receives oily liquid from evaporator 26 through suction line 59 which is coupled to suction line 43 via T-fitting 64. This allows mechanical pump 50 to access oily liquid from the same source as eductor pump 31. Outlet 52 of mechanical pump 50 is coupled to a discharge near the compressor suction inlet 29 which appears in FIG. 1 as nozzle 55 spraying a mist of oily liquid droplets. The mist coming from nozzle 55 is atomized into very fine droplets and carried into the compressor along with the flow of refrigerant gasses entering suction inlet 29 from the evaporator. Preferably the mean particle size produced by the atomizing nozzle is less than 300 microns in diameter, and more preferably less than 100 microns. Nozzle 55 can be any nozzle known to one of ordinary skill in the art for producing such an atomized spray. Examples of nozzle 55 are not limited to any particular form of atomizing nozzle. The preferred form is a heated ceramic nozzle while another example is a mechanically actuated rotating nozzle. It should be further noted that mechanical pump 50 embodied in FIG. 1 is any mechanical pump known to one of ordinary skill in the art as being suitable for pumping the oily liquid from evaporator 26 via suction line 59 to nozzle 55. Examples include, but are not limited to, various types of rotary lobe pumps, progressive cavity pumps, piston pumps, diaphragm pumps, screw pumps, gear pumps, hydraulic pumps, vane pumps, regenerative pumps, or peristaltic pumps. Most preferably the pump is a magnetically coupled gear pump.

The addition of a second pump as envisioned by the invention offers numerous opportunities for enhanced lubricant circulation. In one embodiment of the invention, mechanical pump 50 is added to an existing chiller installation and connected directly to the same power source (not shown) as refrigeration chiller 10 and operates whenever the chiller is operating. In this embodiment, both eductor pump 31 and mechanical pump 50 operate simultaneously at all times to achieve a constant flow of oily liquid back to the compressor regardless of chiller load and corresponding compressor lift. Even if eductor pump 31 ceases to be effective for any reason, mechanical pump 50 continues to return oily liquid to compressor 12 as the mist continuously spraying from nozzle 55 near the compressor suction inlet 29 is constantly drawn into compressor 12.

It is important to note several alternate embodiments from the depictions in FIG. 1. First of all, FIG. 1 indicates evaporator oil skimmer 46 positioned near the surface of the liquid refrigerant capturing oily liquid rising to the surface of the refrigerant pool. However, as previously noted, the density of some refrigerants causes the oily liquid to sink beneath the refrigerant charge. In those cases, suction line 43 would be attached much lower than is depicted in FIG. 1, near the bottom of evaporator 26. Secondly, FIG. 1 also shows both suction lines 43 and 59, as well as high pressure line 36 with filter dryers 48 installed to clean foreign matter such as particulates and water from the refrigeration system. In some embodiments, filter dryers 48 might be absent or positioned elsewhere or of different types. Lastly, in various alternate embodiments of the invention, it may be advantageous for the discharges for eductor pump 31 and mechanical pump 50 to be in the same location. On the other hand, other embodiments may favor two discharge points in different locations near compressor suction inlet 29 such as mounting nozzle 55 directly into compressor suction inlet 29.

Other configurations of mechanical pump 50 are envisioned as well. In one such embodiment of the invention, mechanical pump 50 is added to an existing chiller installation and operated as a backup when compressor lift drops below a minimum preset threshold to avoid excessive oil loss. In this embodiment, mechanical pump 50 is wired into the chiller's existing control system 69 via pump control cable 54 such that when compressor lift drops too low, mechanical pump 50 is activated. When the low lift condition ceases, mechanical pump 50 is deactivated. In another embodiment of the invention, mechanical pump 50 is installed as original equipment to operate simultaneously along with eductor pump 31. These and other embodiments are meant as merely examples of numerous ways in which a mechanical pump system could be used to augment or replace an eductor pump system as a simple and efficient system for circulating oil to prevent excessive oil loss. Although the operational requirements will dictate the optimum arrangement of pumps, suction lines, nozzles, and other elements of the invention, the required circulation of compressor lubricant from the evaporator to the compressor is preferably achieved by pumping the oily liquid from evaporator 26 to a discharge near compressor suction inlet 29.

While the invention has been illustrated and described in detail in the drawings and foregoing description, the same is to be considered as illustrative and not restrictive in character, it being understood that only one embodiment has been shown and described and that all changes, equivalents, and modifications that come within the spirit of the inventions defined by following claims are desired to be protected.

What is claimed is:

1. A system for circulating compressor lubricant from the evaporator of a refrigeration chiller comprising:
A condenser;
An evaporator coupled to the condenser, the evaporator containing a liquid refrigerant phase and an oily liquid having a higher concentration of oil than the liquid refrigerant phase;
A compressor, having a suction inlet, the compressor coupled to the evaporator and the condenser;
An atomizing nozzle positioned to atomize oily liquid within gas coming from within the evaporator, and;
A pump for pumping oily liquid from the evaporator through the atomizing nozzle.

2. The system of claim 1 in which the atomizing nozzle is heated.

3. The system of claim 2 in which the atomizing nozzle is ceramic.

4. The system of claim 1 in which the mean particle size of the atomized droplets produced by the atomizing nozzle is less than 300 microns.

5. The system of claim 4 in which the mean particle size of the atomized droplets produced by the atomizing nozzle is less than 100 microns.

6. The system of claim 1 in which the evaporator is enclosed with a wall, and the atomizing nozzle is positioned in the wall of the evaporator vessel.

7. The system of claim 1 in which said evaporator is a flooded evaporator design.

8. The system of claim 1 in which said compressor is a screw compressor.

9. The system of claim 1 in which the atomizing nozzle is positioned near the compressor suction inlet.

10. A method of retrofitting a refrigeration chiller having a compressor, condenser, and an evaporator all connected in series which comprises:
Adding an atomizing nozzle to a discharge point in the path of vapors passing from the evaporator to the suction inlet of the compressor; and
Adding a pump with its inlet connected to the evaporator at a location that can supply oily liquid, and adding its outlet to the atomizing nozzle.

11. The method of retrofitting of claim 10 in which the step of adding an atomizing nozzle is done to the evaporator.

12. A system for circulating compressor lubricant from the evaporator of a refrigeration chiller comprising:
A condenser;
An evaporator coupled to the condenser, the evaporator containing a liquid refrigerant phase and an oily liquid having a higher concentration of oil than the liquid refrigerant phase;
A compressor, having a suction inlet, the compressor coupled to the evaporator and the condenser;
A first pump for pumping oily liquid from the evaporator to a discharge near the suction inlet; and
A second pump for pumping oily liquid from the evaporator to a discharge near the suction inlet.

13. A system for recovering compressor lubricant of claim 12 where the first pump moves the oily liquid using a high rate of flow of refrigerant vapors past an opening coupled to the oily liquid in the evaporator, whereby both the refrigerant vapors and the oily liquid reach the compressor together.

14. A system for recovering compressor lubricant of claim 12 where the second pump is a mechanical pump.

15. A system for recovering compressor lubricant of claim 12 where the first pump is an eductor.

16. A system for recovering compressor lubricant of claim 12 where the second pump is a magnetically coupled gear pump.

17. A system for recovering compressor lubricant of claim 12 where the discharge of the first pump is at a different location from the discharge of the second pump.

18. The system of claim 12 in which the first pump and the second pump operate simultaneously at all times.

19. The system of claim 12 additionally comprising means for automatically operating the second pump to assist the first pump substantially only during low refrigeration and not during high refrigeration.

20. The system of claim 12 in which said evaporator is a flooded evaporator design.

21. The system of claim 12 in which said compressor is a screw compressor.

22. A system for recovering compressor lubricant of claim 12 where the discharge path of the second pump includes an atomizing nozzle.

23. A system for recovering compressor lubricant of claim 22 where the discharge path of the second pump includes a heated nozzle.

24. A system for recovering compressor lubricant of claim 22 in which the mean particle size of the atomized droplets produced by the atomizing nozzle is less than 300 microns.

25. A system for recovering compressor lubricant of claim 22 in which the mean particle size of the atomized droplets produced by the atomizing nozzle is less than 100 microns.

26. The method of installing an auxiliary system for circulating compressor lubricant from the evaporator to the compressor of a refrigeration chiller that already has a first pump for circulating lubricant the steps comprising:
Obtaining a second pump having an inlet and an outlet;
Coupling the second pump outlet to the compressor suction inlet; and
Coupling the second pump inlet to the evaporator.

27. The method of claim 26 which additionally includes installing a control for the second pump that operates the second pump part time, whereby the capacity of the first pump can be automatically supplemented when desired and can be automatically disabled when not desired.

28. The method of claim 26 which additionally includes installing a spray nozzle near the compressor suction inlet for spraying oil from the second pump.
